(19) United States
(12) Patent Application Publication
(10) Pub. No.: US 2008/0192105 A1
(43) Pub. Date: Aug. 14, 2008

(54) Digital printing apparatus fittable in a flexographic printing system

(75) Inventors: Neil R. Sembower, Webster, NY (US); Dennis C. DeYoung, Webster, NY (US); Jorge A. Alvarez, Webster, NY (US); James M. Chappell, Webster, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/706,112

(22) Filed: Feb. 13, 2007

(51) Int. Cl. B41J 2/415

(52) U.S. Cl. 347/124

(57) ABSTRACT

A system for printing comprises a rotatable charge-retentive member; imaging means for creating an electrostatic latent image on the imaging surface; and development means for applying a development material to the electrostatic latent image on the imaging surface. The developed image has a raised portion, suitable for transferring a liquid-ink image related to the developed image to a receiving surface. The system can be fitted into a flexographic printing apparatus.

### CROSS REFERENCE TO RELATED APPLICATIONS

The following U.S. patent applications are hereby cross-referenced: U.S. patent application Ser. No. 11/239,072 filed Sep. 30, 2005 by Gabriel Iftime et al, “Reimageable Printing Member” (Attorney File No. 20041820); U.S. patent application Ser. No. 11/239,212 filed Sep. 30, 2005 by Gabriel Iftime et al, “Reimageable Printing Member” (Attorney File No. 20041671); U.S. patent application Ser. No. 11/268,303, filed Nov. 7, 2005 by Mark B. Rene, “Printing System Using Shape-changing Materials” (Attorney File No. 20050523); U.S. patent application Ser. No. 11/613,152 filed Dec. 19, 2006 by Jurgen H. Daniel et al, “Printing Plate And System Using Heat-Decomposable Polymers” (Attorney File No. 20051847); and U.S. patent application Ser. No. 11/644,067 filed Dec. 22, 2006 by Ashish Pattekar et al, “An Improved Method Of Forming A Reconfigurable Relief Surface Using Microvalves” (Attorney File No. 20060604).

### TECHNICAL FIELD

The present disclosure relates to adapting printing technologies that are not traditionally compatible with accepting digital image data, such as flexography, for digital printing.

### BACKGROUND

Since the invention of printing, numerous basic techniques for applying ink in an imagewise fashion to a print sheet have been proposed and implemented. In one strategy a printing “plate” (which could also be a belt or other member) defines a surface having raised portions corresponding to an image desired to be printed. Liquid ink is applied to the raised portions, and then the plate is pressed against a sheet to receive the inked image, much in the manner of a rubber stamp. One technology that currently uses this concept is called “flexography,” so called because the plate is typically in the form of a flexible plastic sheet with imagewise-raised portions. Although one plate can place the same image on an essentially unlimited number of prints, every new image to be printed requires a dedicated plate to be made.

An alternate type of printing is called “gravure” printing. Gravure printing is similar to flexographic printing, except that, instead of the raised portions of the plate accepting and transferring liquid ink, liquid ink applied to the plate is retained in shallow cavities in the plate, the cavities corresponding to the print-black portions of the image. Once again, however, every new image to be printed requires a dedicated plate to be made.

As is well known, in the last few years digital printing technologies, such as xerographic “laser” printing and ink-jet printing, have become prevalent. The basic advantages of the digital printing technologies are that the dedicated plates used in older printing techniques do not have to used (or discarded after use), and every printed image can be different, as the images depend solely on the digital image data supplied to the apparatus.

The present disclosure relates to, inter alia, a system by which a pre-existing design for a flexographic or gravure printing system can be adapted to act like a digital printing apparatus, thus obtaining the practical advantages of a digital-based system in a high-volume, high-speed context.

U.S. Pat. Nos. 5,436,706; 5,826,147; and 6,125,750; as well as the pending US patent applications cross-referenced above, each teach a variation of a traditional xerographic, flexographic, or gravure printing method.

### SUMMARY

According to one embodiment, there is provided an apparatus useful in printing, comprising: a rotatable charge-retentive member, defining an imaging surface; imaging means for creating an electrostatic latent image on the imaging surface; and development means for applying a development material to the electrostatic latent image on the imaging surface, forming a developed image. The developed image has a portion of a first type and a portion of a second type, the portion of the first type including development material and being raised relative to the portion of the second type, the developed image being thereby suitable for transferring a liquid-ink image related to the developed image to a receiving surface.

According to another embodiment, there is provided a method of printing, comprising: providing a rotatable charge-retentive member, defining an imaging surface; creating an electrostatic latent image on the imaging surface; and applying a development material to the electrostatic latent image on the imaging surface, forming a developed image. The developed image has a portion of a first type and a portion of a second type, the portion of the first type including development material and being raised relative to the portion of the second type, to be thereby suitable for transferring a liquid-ink image related to the developed image. Liquid ink is applied to the developed image, and the liquid ink is transferred from the developed image to a sheet.

### BRIEF DESCRIPTION OF THE DRAWINGS

FIG. 1 is a simplified elevational view of a flexographic printing station adapted according to the present disclosure.

FIGS. 2 and 3 are partial views of a portion of a charge receptor surface.

### DETAILED DESCRIPTION

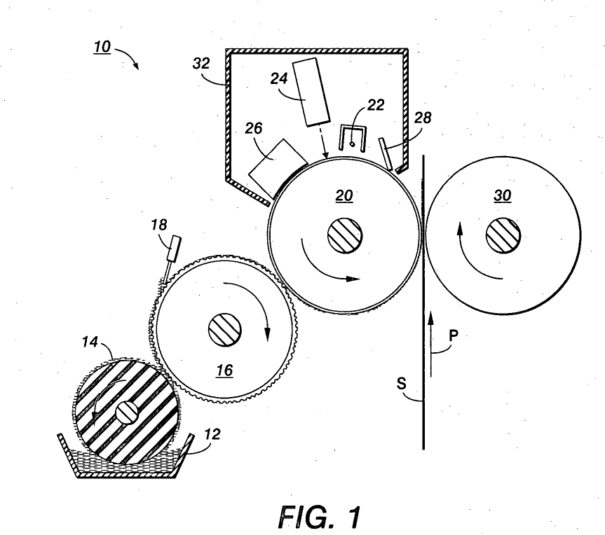

FIG. 1 is a simplified elevational view of a flexographic printing station, generally indicated as 10, adapted according to the present disclosure. The objective in FIG. 1 is to apply a liquid-ink image to a sheet S moving in a process direction P. Although the illustrated station 10 is intended to apply ink of one color to the sheet S, a number of such stations can be arranged along a sheet path to provide successive primary-color separations forming a full-color image on the sheet S.

Liquid ink is supplied to station 10 at a fountain pan 12, of a type familiar in the art. Partially submerged in the ink in pan 12 is a rubber ink-fountain roll 14, again of a type familiar in the art. Roll 14 in turn supplies ink to what can generally be called an “applicator,” such as including an anilox roll 16. As is familiar in the art, an anilox roll typically defines a set of small cavities in its surface, to convey liquid ink thereon. Ink obtained by anilox roll 16 is doctored by doctor blade 18 soon after being picked up from roll 14.

The anilox roll 16 applies the liquid ink to the surface of a charge-receptor 20. In brief, charge receptor 20 acts in a way largely similar to that of a photoreceptor in the well-known process of xerography: an electrostatic latent image is created in the charge-retentive surface of the charge receptor 20, and the image is developed with a dry toner that adheres electrostatically to the suitably-charged portions of the latent image. As shown, there is provided at locations around the circumference of charge receptor 20 a charge device 22 for placing an initial even charge on the surface of charge receptor 20, followed along the direction of rotation by an imaging device 24, which selectably discharges pixel-sized areas according to digital data applied thereto. Familiar types of imaging device in this context include a rotating-mirror raster output scanner (ROS) or an LED bar. The functions of charge device 22 and imaging device 24 could alternatively be provided by an ionographic printhead.

Following imaging device 24 along the direction of rotation of charge receptor 20 is a development unit 26, which may be of any type known in the art of xerography, such as single-component, magnetic-brush, etc. The development unit 26 applies dry toner to the charge receptor 20 so that the toner electrostatically adheres to suitably-charged areas on the electrostatic latent image.

The system of the present disclosure differs from traditional xerography as follows. In traditional xerography, the toner itself is ultimately transferred from the charge receptor to the print sheet to act as a colorant in the printed image. With the system of the present disclosure, the dry toner forming the developed image on the charge receptor is never transferred to a sheet or to any other member; rather, the toner layer forming the developed image is used to accept liquid ink received on the charge receptor from the applicator, in this case anilox roll 16.

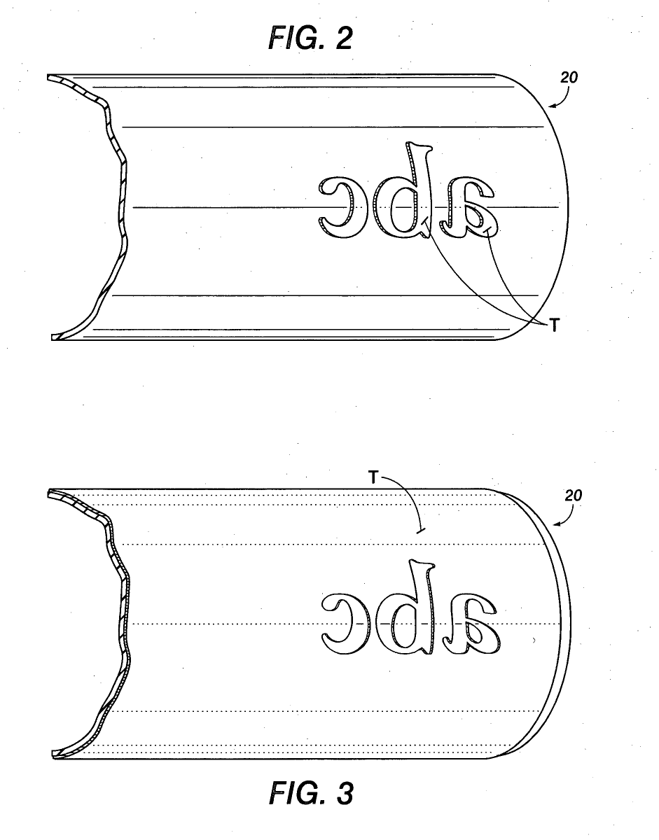

FIGS. 2 and 3 are partial views of a portion of a charge receptor surface, showing how, after development, the surface defines portions of a first type and a second type. In one embodiment, such as shown in FIG. 2, the toner layer is raised relative to the bare surface of charge receptor 20, and, when anilox roll 16 applies liquid ink to the developed image, the raised toner layer retains the liquid ink for transfer to sheet S, in the manner of a flexographic plate or rubber stamp. In an alternative embodiment, such as shown in FIG. 3, a “gravure” model is used, in which the non-raised portion of the developed image, i.e., the bare charge receptor surface, is intended to retain ink for transfer to sheet S. The relative liquid-ink retention properties of the toner layer and the bare charge receptor surface influence which type of ink retention is used. Depending on the implementation, the surface of charge receptor 20 can be designed to resist the ink sticking to it.

Returning to FIG. 1, once the developed image receives liquid ink from anilox roll 16, the liquid ink carried by the developed image is transferred to sheet S, for printing in a flexographic or gravure fashion. In the embodiment, electrostatic forces are largely irrelevant to the transfer of the liquid ink to the sheet S. On the opposite side of sheets S is provided an impression cylinder 30 as shown. In one possible embodiment, the impression cylinder 30 can be charged in such a way as to help maintain the toner on the charge receptor roll 20. Soon after transfer, a cleaning blade 28 (or equivalent device) removes both the toner layer and the residual liquid ink from the surface of charge receptor 20. After the surface is cleaned, the surface can be charged at charge device 22, and re-imaged with imaging device 24. In this way, with every rotation of charge receptor 20, a new image, based on digital data, can be printed on moving sheet S.

In one possible variant, cleaning blade 28 (or an equivalent device) can be selectably disengaged from charge receptor 20, so that the developed toner layer is not disturbed for the following rotation of the charge receptor 20. In such a case, the toner layer (and, thus, the image it represents) remains on the charge receptor for another rotation of charge receptor 20 and, thus, repeated printing of the image on sheet S. In other words, the cleaning and re-creation of new toner layer images on the charge receptor 20 can be made to occur only when the image is desired to be changed; a toner layer can be used for multiple rotations of charge receptor 20, and thus can make multiple images on moving sheet S.

In one possible implementation, the creation of the developed toner-layer image on the charge receptor 20 can be performed in an operational mode separate from the use of the toner layer to print images on the sheet S. For example, in an “image creation” mode, the sheet S and the anilox roll 16 are effectively disengaged from the charge receptor 20, while the developed image is created; then, once the developed image is in place on the charge receptor 20, the “xerographic” elements are switched off, and the anilox roll 16 starts supplying ink to the developed image for printing on sheet S, in a “printing” mode. During a mode wherein a toner layer image is created electrostatically on charge receptor 20, it may be desirable to rotate the charge receptor 20 at a relatively slow rotational speed, in order to obtain a toner layer of desirable properties, such as thickness. When the developed image is used to print on sheet S with liquid ink, however, the requirements of the printing mode may allow charge receptor 20 to be rotated at a significantly higher speed.

In the embodiment of FIG. 1, it can be seen that charge receptor 20, charge device 22, imaging device 24, development unit 26, and cleaning blade 28 are encased in a cartridge 32 (although the development unit 26 itself could be formed of a separate cartridge). The cartridge 32 could be configured to fit in a pre-existing flexographic apparatus: it is familiar in flexographic printing to have to replace the flexographic plate (which corresponds to charge receptor 20) on a regular basis.

In another implementation, the separate “image creation” and “printing” operational modes, as described above, can be carried out in separate apparatus. In a pre-existing print-shop arrangement, where there is already a flexographic printer, an offline apparatus can be provided, the offline apparatus including all of the elements shown in cartridge 32. The offline apparatus creates a charge receptor 20 developed with an image desired to be printed; after the charge receptor is developed with a desired image to be printed, the developed charge receptor is removed from the offline apparatus and placed in the existing flexographic printer, as though it were just another cylindrical flexographic printing plate. When the particular print job is complete, the developed charge receptor 20 is removed from the flexographic printer, effectively erased, and re-imaged for another job.

It will be noted that the toner or other development material applied by development unit 26 to the charge receptor 20 will have properties different from those typically required by toner used in traditional xerography. For instance, because the toner in the embodiment never contacts the print sheet S, the color of the toner is irrelevant. Because a reasonably thick toner layer is desired on the charge receptor 20 to obtain the desired properties, considerations of particle size are different from those of traditional toners. Because the toner is not fused onto a print sheet, considerations of melting points are different from those of traditional toners.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. An apparatus useful in printing, comprising:
a rotatable charge-retentive member, defining an imaging surface;
imaging means for creating an electrostatic latent image on the imaging surface;
development means for applying a development material to the electrostatic latent image on the imaging surface, forming a developed image;
the developed image having a portion of a first type and a portion of a second type, the portion of the first type including development material and being raised relative to the portion of the second type, the developed image being thereby suitable for transferring a liquid-ink image related to the developed image to a receiving surface.

2. The apparatus of claim 1, further comprising
an applicator for applying liquid ink to the developed image.

3. The apparatus of claim 2, the applicator including an anilox member.

4. The apparatus of claim 1, the liquid ink being retained on the developed image substantially not by electrostatic forces.

5. The apparatus of claim 1, the imaging means including an ionographic printhead.

6. The apparatus of claim 1, the imaging means including a charge corotron for creating an initial charge on the imaging surface and a light emitter for selectably discharging portions of the imaging surface according to digital image data.

7. An apparatus fittable in a flexographic printing apparatus, the apparatus substantially replacing a flexographic roll interposed between an anilox member and an image-receiving sheet, comprising:
a rotatable charge-retentive member, defining an imaging surface;
imaging means for creating an electrostatic latent image on the imaging surface;
development means for applying a development material to the electrostatic latent image on the imaging surface, forming a developed image;
the developed image having portions of a first type and portions of a second type, the portions of the first type being raised above the portions of the second type and suitable for receiving liquid ink from the anilox member and transferring the liquid ink thereon to the image-receiving sheet.

8. A method of printing, comprising:
providing a rotatable charge-retentive member, defining an imaging surface;
creating an electrostatic latent image on the imaging surface;
applying a development material to the electrostatic latent image on the imaging surface, forming a developed image, the developed image having a portion of a first type and a portion of a second type, the portion of the first type including development material and being raised relative to the portion of the second type, the developed image being thereby suitable for transferring a liquid-ink image related to the developed image;
applying liquid ink to the developed image; and
transferring the liquid ink from the developed image to a sheet.

9. The method of claim 8, the liquid ink being retained on the developed image substantially not by electrostatic forces.

10. The method of claim 8, the liquid ink being transferred to the sheet substantially not by electrostatic forces.

11. The method of claim 8, further comprising:
performing the creating and applying the development material steps in a first operational mode; and
performing the applying liquid ink and transferring steps in a second operational mode.

12. The method of claim 11, further comprising:
rotating the charge-retentive member at a first rotational speed in the first operational mode; and
rotating the charge-retentive member at a second rotational speed in the second operational mode.

13. The method of claim 11, further comprising:
following the first operational mode, installing the charge-retentive member in a printing apparatus.
